(19) United States
(12) Patent Application Publication
(10) Pub. No.: US 2003/0230675 A1
(43) Pub. Date: Dec. 18, 2003

(54) Rotor inductance propulsion system

(76) Inventor: John Quincy St. Clair, San Juan, PR (US)

Correspondence Address: John St. Clair, Hyperspace Research Institute, 52 Kings Court, 4A, San Juan, PR, 00911, US

(21) Appl. No.: 10/170,847

(22) Filed: Jun. 12, 2002

(51) Int. Cl. B64G 1/40; B64G 1/42

(52) U.S. Cl. 244/172

(57) ABSTRACT

The invention is a spacecraft having a circular, domed hull around which dual electrically-charged rotors one above the other are counter-rotating on the edge of the hull. Embedded in the hull are three solenoids which create a positive vector potential at the rotors. The surface charge density times the radius times the vector potential times the area of the rotors creates an angular momentum in the vertical direction. This angular momentum produces a positive spacetime curvature over the dome of the hull and a negative spiking spacetime compression over the rotors. By machining circumferential grooves of decreasing height along the radius of the rotor, a negative surface inductance is generated. This negative inductance gradient times the negative spacetime compression time the rotor current density squared times the rotor area squared is a positive lift force on the spacecraft.

### BRIEF SUMMARY OF THE INVENTION

The invention, which is the object of my present application, is a spacecraft with a circular, domed hull around which are located dual electrically-charged counter-rotating rotors. The top surface of the upper rotor is etched with circular metallic grooves which give the rotor a surface inductance. The groove height decreases from the inside radius to the outside radius of the rotor giving it a radial inductance gradient. The surface charge density times the angular velocity produces a current density. The counter-rotating rotors produce a negative spacetime curvature over the rotors. The negative surface inductance gradient times the negative spiking spacetime curvature times the current density squared times the area squared is the positive lift force on the rotor.

### REFERENCE WORKS

Gravitation, Wheeler

Traveling-Wave Tubes, The Bell System Technical Journal, Vol. XXIX, January 1950, No. 1, J. R. Pierce.

The Magnetron as a Generator of Centimeter Waves, The Bell System Technical Journal, Vol. XXV, April 1946, No. 2, J. B. Fisk, H. D. Hagstrum, P. L. Hartman.

Lectures on Physics, Richard Feynman

Geometry of Electromagnetism, Paul Hammond

### BACKGROUND OF THE INVENTION

I was reading several articles about the development of the magnetron during World War II in the Bell System Technical Journal. I was trying to understand why the device resonates because it must contain a spring constant which would arise from an inductance and capacitance due to the geometry of the cavity. As given by Feynman, inductance of a solenoid is the permeability of space times the turns per length squared times the volume of the solenoid. Referring to FIG. 1, the magnetron cavity (A) has a circular region connected to a planar region. The electrical current flows on the sides of the cavity shown by the arrows (B). In this case, there is only one turn per height of the cavity times the volume of the cavity times the permeability which produces the inductance. The two planar regions produce a capacitance across the ends which creates the resonant frequency.

From my previous patent application Dual Rotor Propulsion System I know that the two rotors produce a current density in the angular direction along the rotor. If I spread out the magnetron cavity into a circular groove around a rotor, then the current would flow on the side walls enclosing the groove volume. The rotors also produce a spacetime curvature profile as shown in FIG. 2. Curve (A) is a positive spacetime curvature tension over the dome. Curve (B) is a negative spiking spacetime curvature over the rotors. The curvature is measured in inverse meter squared. So the surface inductance times the negative curvature times the current density squared times the rotor area squared is magnetic energy. The differential of the magnetic energy would be a force. So there has to be a gradient of the surface inductance. The volume element of a groove is equal to the circumferential length times the height times the width of the groove. The easiest is to vary the height with radius. Since the curvature is negative, the gradient has to be negative as well in order to get a positive lift force. Thus the height goes from large to small from the inside to the outside radius.

### SUMMARY OF THE INVENTION

The invention relates to a spacecraft with a domed, circular hull of elliptical cross-section having dual electrically-charged counter-rotating rotors located one above the other on the edge of the hull. The upper rotor is positively charged and rotates clockwise with a negative angular velocity per the right-hand rule. The lower rotor is negatively charged and rotates with a positive angular velocity. The current density is the surface charge density times the velocity of the rotor. This particular combination of velocity and charge produces an angular momentum which creates a negative spiking spacetime curvature over the rotors.

The top surface of the rotor is etched or machined with circular grooves around the rotor. This creates a surface inductance which is equal to the permeability of space times the turns per length squared times the volume of the groove. In this case, there is only one turn per height of the groove. If the height of the groove decreases from one groove to the next, then there is a negative surface inductance gradient in the radial direction. So the lift force on the rotors would be the negative surface inductance gradient times the negative spacetime curvature times the current density squared times the rotor area squared.

### STATEMENT REGARDING FEDERALLY SPONSORED RESEARCH OR DEVELOPMENT

Not Applicable.

### A BRIEF DESCRIPTION OF THE DRAWINGS

FIG. 1. Perspective of magnetron cavity.

FIG. 2. Spacetime curvature G_{zz} over hull and rotor.

FIG. 3. Perspective view of spacecraft with dual rotors.

FIG. 4. Wire frame view of three solenoids.

FIG. 5. Vector potential equation for solenoid.

FIG. 6. Units of vector potential.

FIG. 7. 3D graph of vector potential using three solenoids.

FIG. 8. Perspective of vector potential along rotors.

FIG. 9. Rotor mechanics diagram using exponential representation.

FIG. 10. Angular momentum equation due to vector potential and rotating charged rotors.

FIG. 11. Units of angular momentum.

FIG. 12. Exponential equation for twice imaginary sine of the angle.

FIG. 13. Angular momentum equation for g metric tensor.

FIG. 14. Angular momentum term for elemental line length ds².

FIG. 15. The g metric tensor containing the angular momentum.

FIG. 16. The spacetime curvature tension G_{zz} versus radius due to angular momentum.

FIG. 17. Magnetic energy equation.

FIG. 18. Units of magnetic energy.

FIG. 19. Cross-section of rotor showing groove height gradient.

FIG. 20. Equation for the height h of the rotor groove as a function of radius.

FIG. 21. Equation for the groove inductance gradient.

FIG. 22. Plot of the groove inductance gradient as a function of radius showing that it is negative at the rotor.

FIG. 23. Lift force on rotors due to inductance gradient, compression curvature, rotor current density and area.

### DETAILED DESCRIPTION OF THE INVENTION

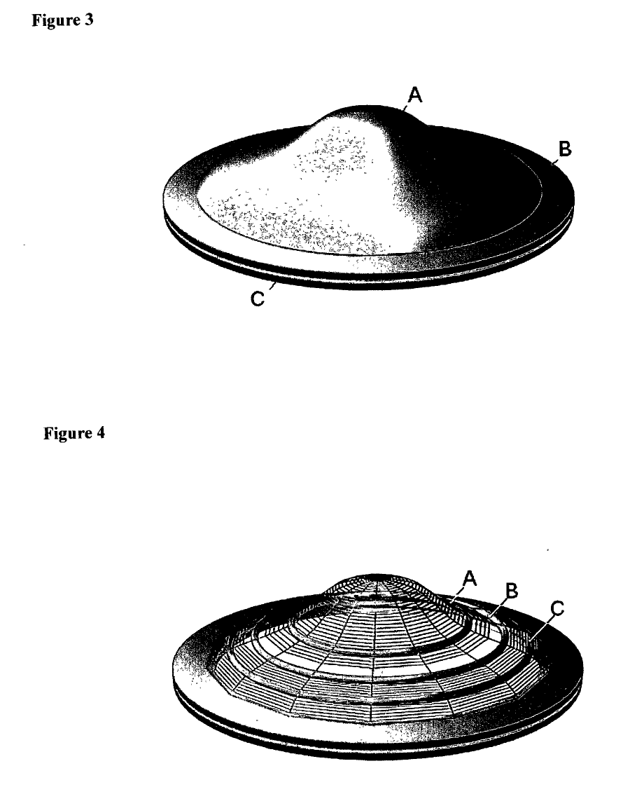

1. Referring to FIG. 3, the spacecraft has a circular, domed hull of elliptical cross-section with dual electrically-charged counter-rotating rotors one above the other on the edge of the hull.

2. Referring to FIG. 4, embedded within the hull are three solenoids or current loops carrying a constant electrical current in the positive sense per the right-hand rule.

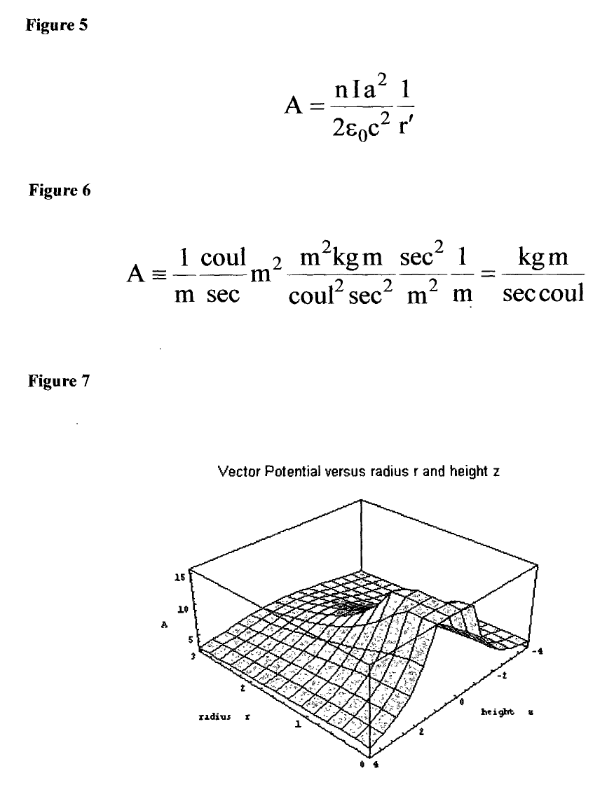

3. Referring to FIG. 5, Feynman has shown that the vector potential {A} of a solenoid is equal to the number of turns per length {n} times the current {I} times the radius of the solenoid {a} squared divided by half the permittivity of space {ε₀} times the speed of light {c} squared times the radius {r′} prime from the center of the coil to some location in space such as the rotors. It has been found by physicists Bohm and Aharanov that the vector potential field is not confined to an infinitely long solenoid as is the magnetic B field. The vector potential has units of kilogram-meter per second-coulomb as seen in FIG. 6.

4. Referring to FIG. 7, the three solenoids of varying radius and area produce a positive vector potential at the centerline of the rotors as seen in the graph.

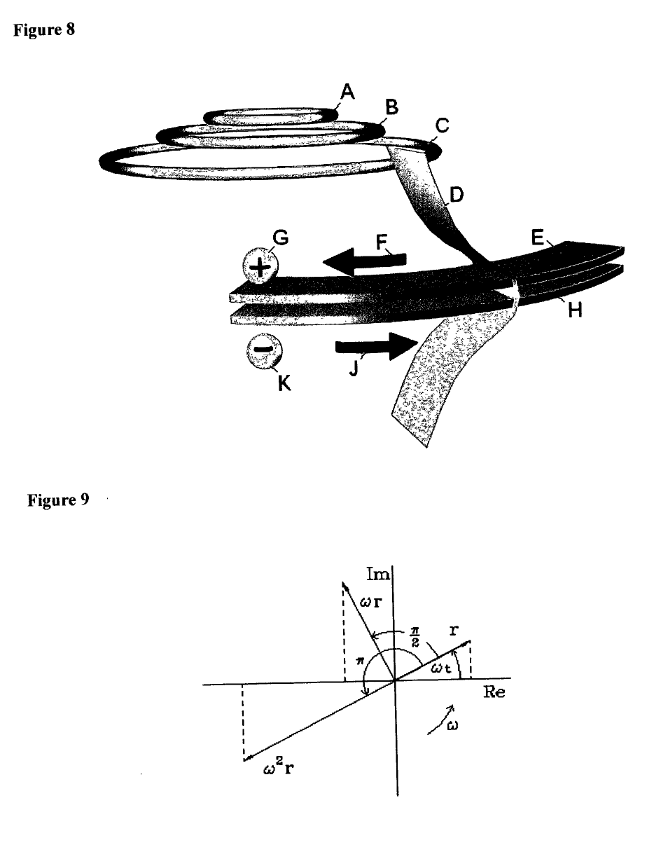

5. This graph is then rotated ninety degrees so that it can be located in relation to the rotors as seen in FIG. 8. The vector potential (D), which is created by solenoids (A,B,C), passes through rotors (E) and (H). Rotor (E), which has a positive charge (G), is rotating clockwise (F), and rotor (H), which has a negative charge (K), is rotating counter-clockwise (J).

6. Referring to FIG. 9, rotor mechanics uses the exponential function for the harmonic motion of the rotor. The radius is {r e^{iωt}} which when differentiated with respect to time becomes a velocity {i ω r e^{iωt}} where the imaginary {i} is a 90° phase lead which makes the velocity tangential to the rotor.

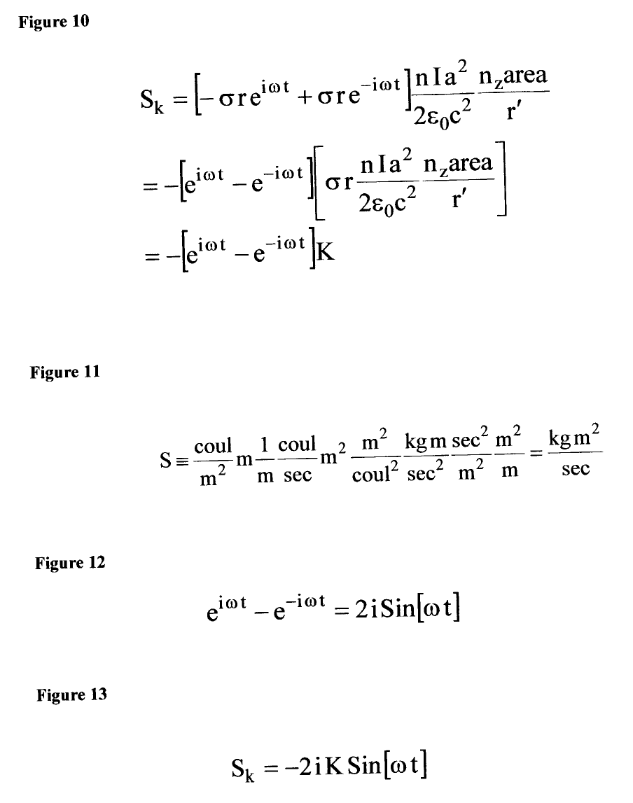

7. The rotor surface charge {σ sigma} is rotating around at some radius {r}. For the upper rotor the surface charge density is positive (+σ} but the rotor has a negative angular velocity {−ω}. For the lower rotor, the surface charge density is negative {−σ} but the rotor has a positive angular velocity {+ω}. So the combined surface charge rotation is {−σ r e^{iωt}+σ r e^{-iωt}}. This charge rotation times the positive vector potential due to the solenoids times the rotor surface area is equal to angular momentum S as shown in FIG. 10. The units are given in FIG. 11. The angular momentum is equal to the negative of the difference of the exponentials times a constant. I then recalled that this difference is equal to twice imaginary sine of the angle as shown in FIG. 12.

8. Referring to FIG. 13, the angular momentum is equal to minus two times the imaginary number times a constant times the sine of the rotational angle. In most of my spacecraft designs, the electromagnetic fields determine the flow rate of angular momentum. When the flow rate is integrated with respect to time, the angular momentum becomes imaginary. In this invention, the angular momentum is imaginary due directly to the rotors. The importance of being imaginary is that the radius resonates with the angular momentum. In some spacetime curvature equations, the denominator has a term equal to the radius to the fourth power plus twice the square of the angular momentum. In spacetime units, angular momentum is viewed as meter squared. So the square of imaginary angular momentum is negative angular momentum equal to negative meters to the fourth power. So at some radius, these two terms are equal, the denominator goes to zero, and the spacetime curvature becomes infinitely-large, creating a huge spike.

9. This next section calculates the spacetime curvature from the equation for the angular momentum.

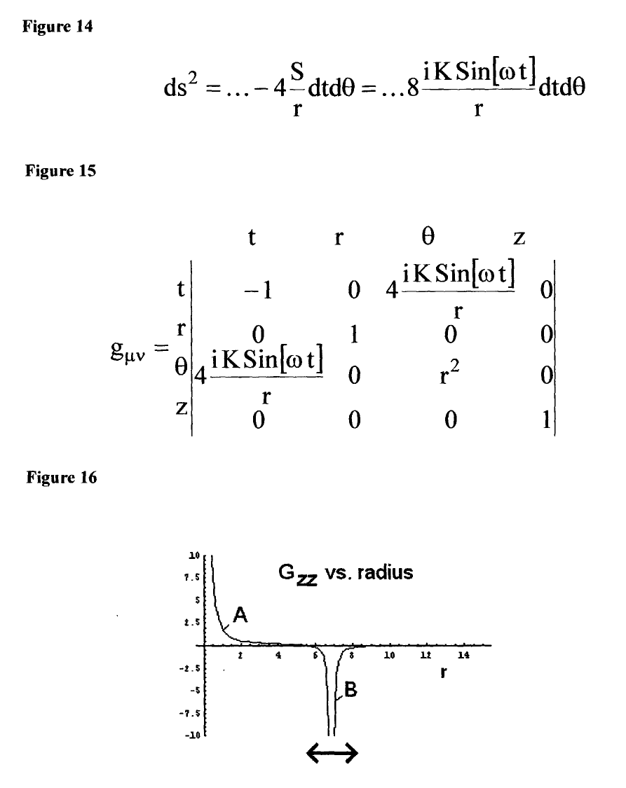

10. Referring to FIG. 14, the elemental length ds² is curved by the presence of the angular momentum which is one of the energies, such as mass, charge, and electromagnetic fields, that Einstein showed can curve spacetime. Because the angular momentum is pointing in the vertical z-direction, due to the direction of the unit normal vector to the surface of the rotor, it rotates around in the angular direction {dtdθ} as found in cylindrical coordinates {t,r,θ,z}.

11. In gravitational physics there is a g metric tensor which is a measure of length in spacetime coordinates. It is a 4 by 4 matrix with rows and columns equal to the cylindrical coordinates. Referring to FIG. 15, the diagonal of the matrix is {−1,1,r²,1} where the minus one corresponds to time which is Einstein's convention. Half the angular momentum goes in the {tθ} slot of the g metric tensor, and the other half goes in the {θt} slot.

12. From this g metric tensor, Einstein's G curvature tensor can be calculated in the various directions. In Einstein's General Theory of Relativity, his equation is G=8πT where G is the spacetime curvature measured in inverse meter squared, and the T tensor is the stress-energy-momentum matrix containing all the electromagnetic pressures, mass and momentum components that curve spacetime. The spacetime curvature tension G_{zz} in the vertical direction, as a function of radius, is shown in FIG. 16. A positive curvature indicates that there is a spacetime tension over the hull which produces lift. The curvature has a large positive spike over the dome of the hull (A) which means that there is a large lift force over the center of the hull. The curvature then falls off and spikes with a negative spacetime curvature compression over the rotors (B). This curvature also oscillates back and forth a short distance due to the sinusoidal term. The problem is to convert this compression into a lift force which this invention solves.

13. This next section shows how the spacetime compression over the rotors generates lift.

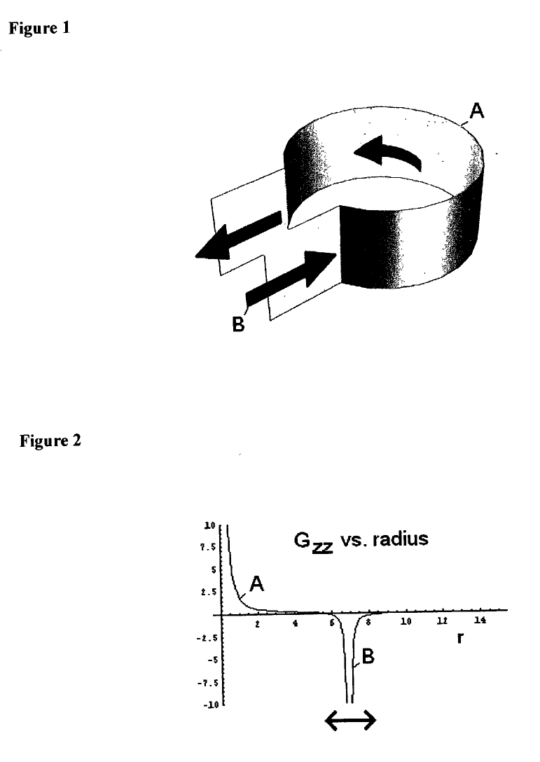

14. As I mentioned, I have been reading some of the World War II magnetron scientific papers of the Bell System Technical Journal. It turns out that inductance of a solenoid is equal to the permeability of space times the number of wire turns per length squared times the volume of the solenoid. Imagine having a copper strip in the shape of the magnetron cavity in FIG. 1. The electrical current (B) flows around the height of the strip (A), so there is only one turn per the height. Then that is multiplied by the volume of the cavity and permeability to get the inductance. The inductor is storing magnetic energy equal to half the inductance times the current squared. In this invention, current density J in amp per meter is used rather than current. So taking a hint from this information, the magnetic energy would have to be related to the inductance times the square of the current density times the area squared of the rotor and times the negative spacetime curvature. The curvature is measured in inverse meter squared. That product produces a negative magnetic energy when in fact I want a positive force. This means that there has to be an inductance gradient in the equation instead of pure inductance and, furthermore, the gradient has to be negative in order to cancel out the negative sign of the compression curvature.

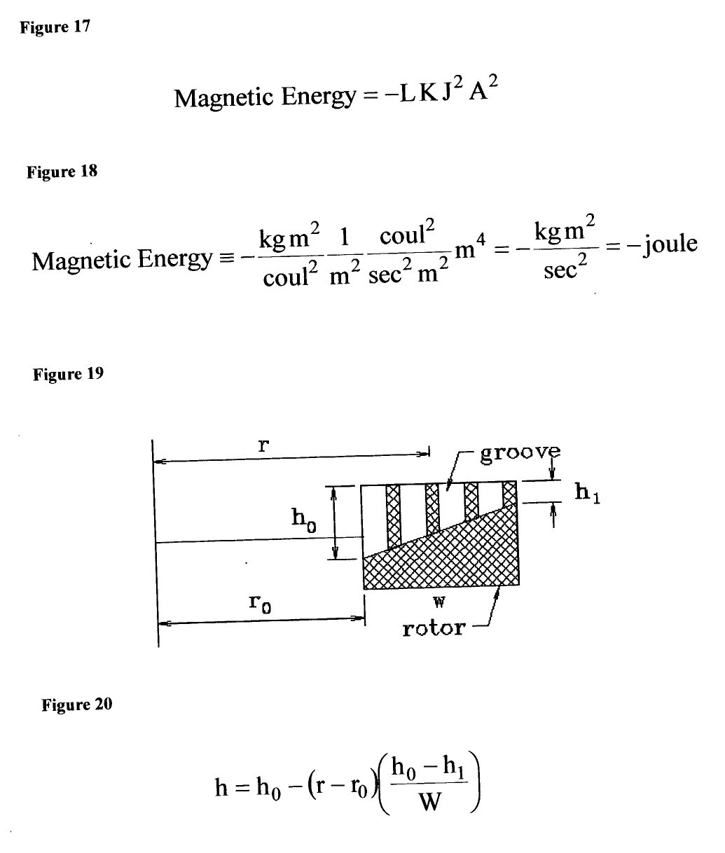

15. The equation for the magnetic energy in terms of the inductance { [symbol] }, curvature {K}, current density {J} and area {A} is shown in FIG. 17 with the units in FIG. 18. The inductance in the equation is proportional to the volume of the circular groove in the top surface of the rotor. That volume is equal to {2π r h w} where {h] is the height of groove (depth) and {w} is the width located at some radius {r}. In terms of machining, it would be more difficult to machine a variable width groove rather than a deeper groove of a constant width. So I am going to say the gradient is in the radial direction with the height of the groove decreasing going from the inside radius to the outside radius as depicted in FIG. 19.

16. FIG. 20 gives the equation for the height of the groove along the radius of the rotor.

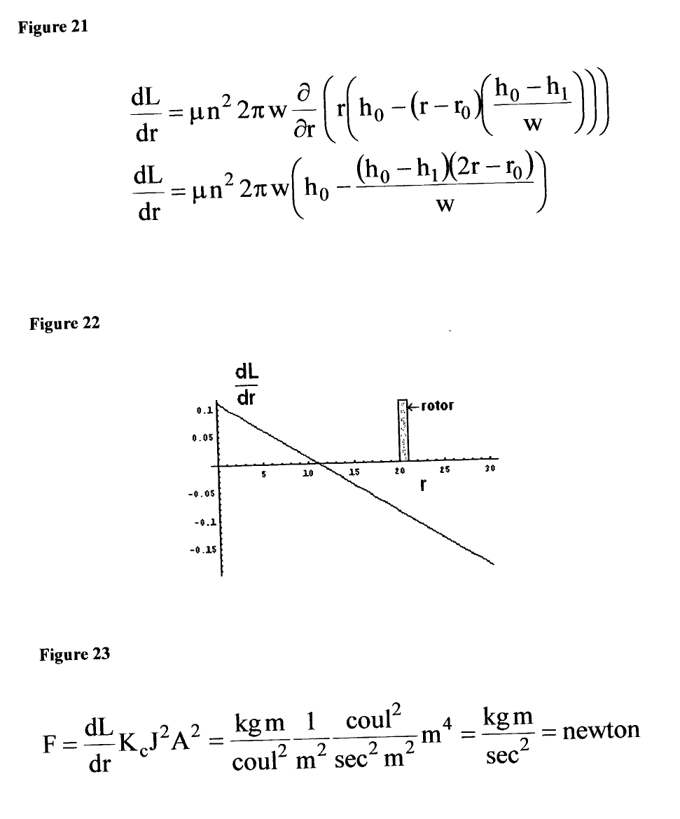

17. FIG. 21 gives the inductance gradient by differentiating the inductance with respect to the radius. The initial groove height ho is not very large, and the inductance gradient becomes negative at the rotor as seen in the graph of FIG. 22.

18. Referring to FIG. 23, the lift force on the rotor is now positive due to the combined negative inductance gradient times the negative spacetime compression. The square of the negative current density is positive also. This means that that the top surface of the lower rotor can also have a surface inductance gradient which would double the lift force.

What I claim as my invention is:

1. A spacecraft having a circular, domed hull with dual electrically-charged counter-rotating rotors one above the other located on the edge of hull.

2. Said hull having embedded within it three or more solenoids which generate a positive vector potential at the rotors.

3. Said upper rotor having a positive surface charge density, and rotating clockwise in the negative direction per the right-hand rule.

4. Said lower rotor having a negative surface charge density, and rotating counterclockwise in the positive direction per the right-hand rule.

5. Said rotor surface charge density and velocity creating a negative current density on both rotors.

6. Said vector potential and rotating surface charge density on rotors generating an angular momentum in the vertical direction.

7. Said angular momentum, generating a spacetime curvature tension over the dome of the hull, and a negative oscillating spacetime curvature compression over the rotors.

8. Said rotors having circumferential grooves of decreasing height machined into the top surface of the rotors in order to create a negative surface inductance gradient.

9. Said negative surface inductance gradient times the negative spacetime curvature compression times the rotor current density squared times the rotor area squared generating a positive lift force on the spacecraft.
